(19) United States
(12) Patent Application Publication
(10) Pub. No.: US 2018/0251588 A1
(43) Pub. Date: Sep. 6, 2018

(54) FUNCTIONALIZED PARTICLES

(71) Applicant: RISE RESEARCH INSTITUTES OF SWEDEN AB, Borås (SE)

(72) Inventors: Eric JOHANSSON SALAZAR-SANDOVAL, Stockholm (SE); Anwar AHNIYAZ, Stockholm (SE)

(21) Appl. No.: 15/753,986

(22) PCT Filed: Aug. 23, 2016
(86) PCT No.: PCT/SE2016/050785

§ 371 Date: Feb. 21, 2018

(30) Foreign Application Priority Data
Aug. 27, 2015 (SE) 1551112-4

(51) Int. Cl. C08F 292/00; C08F 22/10; C08K 3/22; C08K 5/23

(52) U.S. Cl. CPC C08F 292/00; C08K 5/235; C08K 3/22; C08F 22/10

(57) ABSTRACT

Functionalized metal oxide particles comprising, on the surface, a radical of formula I (I) wherein the particle comprises an oxide of a metal; R₁ is C, (CH₂)₁₋₁₂—C, or (CH₂)₁₋₁₂—O(O)C—C₁; R₂ is CR₄R₅, where R₄ and R₅ are independently selected among H and C₁-C₁₂ alkyl; and R₃ is H, halo, C₁-C₁₂ alkyl, or C₁-C₁₂ haloalkyl. A process for the production of the functionalized particles; functionalized particles, obtainable by the process. A process for the production of a polymer composite comprising the functionalized particles; and a polymer composite obtainable by that process.

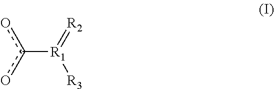

### BACKGROUND

The present invention relates to functionalized particles, to compositions comprising an organic material and functionalized particles, and to nanocomposites comprising functionalized particles; the present invention also relates to a process for production of functionalized particles.

The use of fillers in polymers has the advantage that it is possible to bring about improvement in, for example, the optical, electrical, thermal and mechanical properties, especially the UV absorption, electrical conductivity, thermal conductivity, density, hardness, rigidity and impact strength of the polymer.

By using small filler particles in polymers various properties, such as for instance mechanical properties, long term stability and/or flame retardant property of the polymers can be improved.

WO 2006/045713 discloses functionalized particles comprising on the surface a covalently bound organosilane radical, wherein the particles are SiO₂, Al₂O₃ or mixed SiO₂ and Al₂O₃ particles. The functionalized particles are said to be useful as stabilizers and/or compatibilizers in organic materials, or as photoinitiators in pre-polymeric or pre-crosslinking formulations, or as reinforcer of coatings and improver of scratch resistance in coating compositions for surfaces.

It would be desirable to be able to provide further improved functionalized particles that could be used as a versatile base making additive for improving the performance and durability of components made of polymers and elastomers.

One object of the present invention is to provide such improved functionalized particles.

### SHORT SUMMARY OF THE INVENTION

Thus, one aspect of the invention relates to a functionalized particle comprising, bound to its surface, a radical of formula I

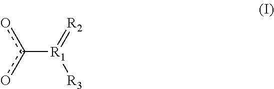

wherein the particle comprises an oxide of a metal; R₁ is C, (CH₂)₁₋₁₂—C, or (CH₂)₁₋₁₂—O(O)C—C; R₂ is CR₄R₅, where R₄ and R₅ are independently selected among H and C₁-C₁₂ alkyl; and R₃ is H, halo, C₁-C₁₂ alkyl, or C₁-C₁₂ haloalkyl.

It has been found that functionalized particle according to the invention also provides for improved properties in terms of, for instance
resistance to UV radiation degradation;
resistance to aging due to diffusion of the particles and/or the molecules bound to them;
resistance to aging due to heat;
resistance to oxidation; and
enhanced fatigue performance.

### BRIEF DESCRIPTION OF THE DRAWINGS

The present invention will be described in closer detail in the following description, examples and attached drawings, in which

FIG. 1 shows E′ (storage modulus) vs. temperature for a polymerized sample comprising functionalized particles according to the invention compared to a similar polymerized sample without any functionalized particles.

FIG. 2 shows tan δ vs. temperature for a polymerized sample comprising functionalized particles according to the invention compared to a similar polymerized sample without any functionalized particles.

### DESCRIPTION OF EMBODIMENTS OF THE INVENTION

Before the present invention is disclosed and described, it is to be understood that this invention is not limited to the particular configurations, process steps, and materials disclosed herein as such configurations, process steps, and materials may vary somewhat. It is also to be understood that the terminology employed herein is used for the purpose of describing particular embodiments only and is not intended to be limiting since the scope of the present invention will be limited only by the appended claims and equivalents thereof.

It must be noted that, as used in this specification and the claims, the singular forms “a”, “an”, and “the” include plural referents unless the context clearly dictates otherwise.

In this specification, unless otherwise stated, the term “about” modifying the quantity of any ingredient, compositions, or products of the invention or employed in the methods of the invention refers to variations in the numerical quantity that can occur, for example, through typical measuring and liquid handling procedures used for making concentrates or use solutions in the real world; through inadvertent errors in these procedures; through differences in the manufacture, source, or purity of the ingredients employed to make the material, compositions, or products, or to carry out the methods; and the like. The term “about” also encompasses amounts that differ due to different equilibrium conditions for a composition resulting from a particular initial mixture. Whether or not modified by the term “about”, the claims include equivalents to the quantities.

In this specification, unless otherwise stated, the term “particle” refers to discrete solid phases. Such solid phases can be of any shape or size. In some embodiments, some or all particles are substantially spherical. In some embodiments, utilized particles have sizes within a defined range and/or showing a defined distribution. In some embodiments the particles have a size in at least one dimension of up to 10 μm, specifically about 1 nm-10 μm, more specifically about 1 nm-1 μm, and even more specifically about 1 nm-100 nm.

In this specification, unless otherwise stated, the term “particle size” or the term “size,” or “sized” as employed in reference to the term “particle(s)”, means volume weighted diameter as measured by conventional diameter measuring devices, such as a Coulter Multisizer. Mean volume weighted diameter is the sum of the mass of each particle times the diameter of a spherical particle of equal mass and density, divided by total particle mass.

The particles may comprise agglomerates and/or aggregates of smaller primary particles.

In this specification, unless otherwise stated, the term “polymer composite” relates to a multicomponent material comprising multiple different phase domains in which at least one type of phase domain is a continuous phase and in which at least one component is a polymer.

In this specification, unless otherwise stated, the term “nanocomposite” relates to a composite material comprising particles having at least one dimension that is less than about 1000 nm in size. In some embodiments, the composite material comprises particles having at least one dimension that is between about 1 nm and 500 nm, specifically between about 1 nm and 100 nm.

In this specification, unless otherwise stated, the term “organic ligand” relates to an organic molecule in which there is at least one site that enables the binding of said ligand molecule to particles resulting in capped particles.

In this specification, unless otherwise stated, the term “halo” relates to any radical of fluorine, chlorine, bromine or iodine. The term “haloalkyl” relates to an alkyl group substituted with one or more halo groups.

In one embodiment the inventive particle consists essentially of an oxide of a metal. In another embodiment the inventive particle consists of an oxide of a metal.

In one embodiment the metal is a transition metal, specifically a rare earth element, more specifically a lanthanide. The metal may in some embodiments be chosen among cerium, zinc, iron, titanium, tin, indium, zirconium, gallium, aluminum, bismuth, chromium, lithium, manganese, nickel, copper, ruthenium and combinations thereof. In one embodiment the metal oxide is CeO₂.

In one embodiment R₁ is C, (CH₂)₁₋₆—C, or (CH₂)₁₋₆—O(O)C—C.

In one embodiment R₂ is CR₄R₅, where R₄ and R₅ are independently selected among H and C₁-C₆ alkyl.

In one embodiment R₂ is CR₄R₅, where R₄ is H and R₅ is C₁-C₆ alkyl.

In one embodiment R₃ is H, halo, C₁-C₆ alkyl, or C₁-C₆ haloalkyl.

In one embodiment R₁ is C or (CH₂)₁₋₃—O(O)C—C; R₂ is CH₂; and R₃ is H, halo, C₁-C₃ alkyl, or C₁-C₃ haloalkyl.

In one embodiment R₁ is C; R₂ is CH₂; and R₃ is H, halo, C₁-C₂ alkyl, or C₁-C₂ haloalkyl.

In one embodiment R₁ is C; R₂ is CH₂; and R₃ is H or C₁ alkyl.

In one embodiment the particle consists of CeO₂; R₁ is C; R₂ is CH₂; and R₃ is H or C₁ alkyl.

Another aspect of the invention relates to a process for the production of functionalized metal oxide particles, comprising the sequential steps of:

(A) providing an aqueous solution of a particle precursor comprising a metal salt;

(B) adding to said aqueous solution a modifier substance of formula II

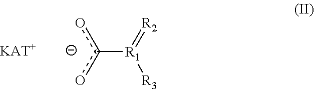

wherein KAT⁺ is H⁺ or an alkali metal; R₁ is C, (CH₂)₁₋₁₂—C, or (CH₂)₁₋₁₂—O(O)C—C; R₂ is CR₄R₅, where R₄ and R₅ are independently selected among H and C₁-C₁₂ alkyl; R₃ is H, halo, C₁-C₁₂ alkyl, or C₁-C₁₂ haloalkyl; and (C) adding to said aqueous solution an oxidizing agent, whereby no part of the process is performed at a temperature exceeding 30° C.

The oxidizing agent may, for example, be selected among superoxides, such as, for instance, CsO₂, RbO₂, KO₂, and NaO₂; hypochlorites, for instance of Na or Ca; chlorates, for instance of K, Na, or Sr; chromates, for instance of K; dichromates, for instance of Na; permanganates, for instance of Ca or K; manganates, for instance of Na, K, or Ca; perborates, for instance of Na; persulfates, for instance of NH₄, Na, or K; chromium trioxide; peroxides, specifically inorganic peroxides such as, for instance, H₂O₂; and combinations thereof.

In one embodiment the aqueous solution of particle precursor consists essentially of a metal salt. In another embodiment the aqueous solution of particle precursor consists of a metal salt.

In one embodiment the metal of the metal salt is a transition metal, specifically a rare earth element, more specifically a lanthanide. The metal may in some embodiments be chosen among cerium, zinc, iron, titanium, tin, indium, zirconium, gallium, aluminum, bismuth, chromium, lithium, manganese, nickel, copper, ruthenium, and combinations thereof. In one embodiment the metal is cerium.

In one embodiment the metal salt is a metal halide, a metal carbonate, a metal sulfate, a metal phosphate, a metal nitrate, a metal alkoxide, or a combination thereof.

In one embodiment the metal salt is a metal C₁-C₁₂ carboxylic acid salt, specifically a metal C₁-C₆ carboxylic acid salt, such as, for instance, a metal formate, metal acetate, or a metal propionate. In one embodiment the metal carboxylic acid salt is cerium(III)acetate.

In one embodiment KAT⁺ is H⁺ or Na⁺.

In one embodiment the oxidizing agent is H₂O₂.

In one embodiment R₁ is C, (CH₂)₁₋₆—C, or (CH₂)₁₋₆—O(O)C—C.

In one embodiment R₂ is CR₄R₅, where R₄ and R₅ are independently selected among H and C₁-C₆ alkyl.

In one embodiment R₂ is CR₄R₅, where R₄ is H and R₅ is C₁-C₆ alkyl.

In one embodiment R₃ is H, halo, C₁-C₆ alkyl, or C₁-C₆ haloalkyl.

In one embodiment R₁ is C or (CH₂)₁₋₃—O(O)C—C; R₂ is CH₂; and R₃ is H, halo, C₁-C₃ alkyl, or C₁-C₃ haloalkyl.

In one embodiment R₁ is C; R₂ is CH₂; and R₃ is H, halo, C₁-C₂ alkyl, or C₁-C₂ haloalkyl.

In one embodiment R₁ is C; R₂ is CH₂; and R₃ is H or C₁ alkyl.

In one embodiment the inventive process is carried out in the substantial absence of any substance that could cause the produced metal oxide particles to precipitate, in particular basic compounds, specifically organic bases, such as alkylamines, for example triethylamine or octylamine.

In one embodiment no part of the process is performed at a temperature exceeding 25° C.

In one embodiment of the inventive process said particle precursor consists of cerium(III)acetate; R₁ is C; R₂ is CH₂; R₃ is H or C₁ alkyl; and the oxidizing agent is H₂O₂.

Another aspect of the invention relates to a functionalized particle that is obtainable by the inventive process. One embodiment of this aspect relates to a functionalized particle that is obtained by the inventive process.

Another aspect of the invention relates to another process for the production of functionalized particles, which process comprises mixing a dispersion of particles of a metal oxide complex with organic ligands with a modifier substance of formula III

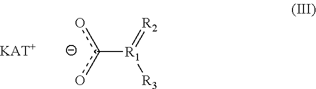

wherein KAT⁺ is H⁺ or an alkali metal; R₁ is C, (CH₂)₁₋₁₂—C, or (CH₂)₁₋₁₂—O(O)C—C; R₂ is CR₄R₅, where R₄ and R₅ are independently selected among H and C₁-C₁₂ alkyl; and R₃ is H, halo, C₁-C₁₂ alkyl, or C₁-C₁₂ haloalkyl.

Methods and sources for obtaining dispersions of particles of metal oxide complex with organic ligands to be used in this process are known in the art. Dispersions suitable for use in the present process include, for example, dispersions commercially available from suppliers such as NYACOL® Nano Technologies, Inc. (Ashland, Mass.); Evonik Degussa Corp. (Parsippany, N.J.); Rhodia, Inc. (Cranberry, N.J.); Byk Chemie GmbH (Germany); Alfa Aesar GmbH & Co KG (Germany); Nanoamorph Technology CJSC (Armenia); Ferro Corporation (Cleveland, Ohio) and Umicore SA (Brussels, Belgium).

In one embodiment the metal of said metal oxide complex with organic ligands is a transition metal, specifically a rare earth element, more specifically a lanthanide. The metal may in some embodiments be chosen among cerium, zinc, iron, titanium, tin, indium, zirconium, gallium, aluminum, bismuth, chromium, lithium, manganese, nickel, copper, ruthenium, and combinations thereof. In one embodiment the metal is cerium.

The organic ligands may, for example, be selected among phosphonates; silanes; amines; starch; carboxylic acid; salts of carboxylic acids; esters; polyelectrolytes, specifically positively charged polyelectrolytes such as, for instance, polyethylene imine (PEI), poly(allylamine hydrochloride) (PAH), poly(diallyldimethylammonium chloride) (PDADMAC) or negatively charged polyelectrolytes such as, for instance, polyacrylic acid (PAA), and [poly(styrene-4-sulfonate (PSS); block-co-polymers, such as poloxamers, for instance of the Pluronic® types (BASF) which are block copolymers based on ethylene oxide and propylene oxide; poly ethylene glycol; polyethylene oxide; and combinations thereof.

In one embodiment said metal oxide complex with organic ligands is a metal oxide C₁-C₆ carboxylate complex, such as, for instance, a metal oxide formate complex, a metal oxide acetate complex, or a metal oxide propionate complex. In one embodiment the metal oxide complex with organic ligands is a ceria acetate complex.

In one embodiment no part of the process is performed at a temperature exceeding 30° C., specifically not exceeding 25° C.

In one embodiment the process is carried for period of about 3-9 hours, specifically about 5-7 hours.

In one embodiment R₁ is C, (CH₂)₁₋₆—C, or (CH₂)₁₋₆—O(O)C—C.

In one embodiment R₂ is CR₄R₅, where R₄ and R₅ are independently selected among H and C₁-C₆ alkyl.

In one embodiment R₂ is CR₄R₅, where R₄ is H and R₅ is C₁-C₆ alkyl.

In one embodiment R₃ is H, halo, C₁-C₆ alkyl, or C₁-C₆ haloalkyl.

In one embodiment R₁ is C or (CH₂)₁₋₃—O(O)C—C; R₂ is CH₂; and R₃ is H, halo, C₁-C₃ alkyl, or C₁-C₃ haloalkyl.

In one embodiment R₁ is C; R₂ is CH₂; and R₃ is H, halo, C₁-C₂ alkyl, or C₁-C₂ haloalkyl.

In one embodiment R₁ is C; R₂ is CH₂; and R₃ is H or C₁ alkyl.

In one embodiment the metal oxide complex with organic ligands consists of cerium(III)acetate; KAT⁺ is H⁺; R₁ is C; R₂ is CH₂; and R₃ is H or C₁ alkyl.

Another aspect of the invention relates to a functionalized particle that is obtainable by the inventive process. One embodiment of this aspect relates to a functionalized particle that is obtained by the inventive process.

Another aspect of the invention relates to a process for the production of a polymer composite comprising functionalized particles, which process comprises the sequential steps of:

(1) Mixing a dispersion of particles of a metal oxide complex with organic ligands with a polymerizable monomer substance;

(2) Adding to the mixture obtained from step (1) a modifier substance of formula IV

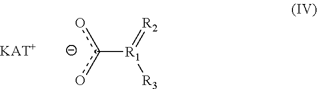

wherein KAT⁺ is H⁺ or an alkali metal; R₁ is C, (CH₂)₁₋₁₂—C, or (CH₂)₁₋₁₂—O(O)C—C; R₂ is CR₄R₅, where R₄ and R₅ are independently selected among H and C₁-C₁₂ alkyl; R₃ is H, halo, C₁-C₁₂ alkyl, or C₁-C₁₂ haloalkyl; and

(2) Adding a polymerization initiator to the mixture obtained from step (2).

Methods and sources for obtaining dispersions of particles of metal oxide complex with organic ligands to be used in this process are known in the art. Dispersions suitable for use in the present process include, for example, dispersions commercially available from suppliers such as NYACOL® Nano Technologies, Inc. (Ashland, Mass.); Evonik Degussa Corp. (Parsippany, N.J.); Rhodia, Inc. (Cranberry, N.J.); Byk Chemie GmbH (Germany); Alfa Aesar GmbH & Co KG (Germany); Nanoamorph Technology CJSC (Armenia); Ferro Corporation (Cleveland, Ohio) and Umicore SA (Brussels, Belgium).

In one embodiment the metal of said metal oxide complex with organic ligands is a transition metal, specifically a rare earth element, more specifically a lanthanide. The metal may in some embodiments be chosen among cerium, zinc, iron, titanium, tin, indium, zirconium, gallium, aluminum, bismuth, chromium, lithium, manganese, nickel, copper, ruthenium, and combinations thereof. In one embodiment the metal is cerium.

The organic ligands may, for example, be selected among phosphonates; silanes; amines; starch; carboxylic acid; salts of carboxylic acids; esters; polyelectrolytes, specifically positively charged polyelectrolytes such as, for instance, polyethylene imine (PEI), poly(allylamine hydrochloride) (PAH), poly(diallyldimethylammonium chloride) (PDADMAC) or negatively charged polyelectrolytes such as, for instance, polyacrylic acid (PAA), and [poly(styrene-4-sulfonate (PSS); block-co-polymers, such as poloxamers, for instance of the Pluronic® types (BASF) which are block copolymers based on ethylene oxide and propylene oxide; poly ethylene glycol; polyethylene oxide; and combinations thereof.

In one embodiment said metal oxide complex with organic ligands is a metal oxide C₁-C₆ carboxylate complex, such as, for instance, a metal oxide formate complex, a metal oxide acetate complex, or a metal oxide propionate complex. In one embodiment the metal oxide complex with organic ligands is a ceria acetate complex.

In one embodiment step (1) and (2) are performed at a temperature not exceeding 30° C., specifically not exceeding 25° C.

In one embodiment step (1) and (2) are carried for a combined period of about 3-9 hours, specifically about 5-7 hours.

In one embodiment step (3) is performed at a temperature in the range of about 30-90° C., specifically 40-85° C.

In one embodiment step (3) is carried for a period of about 10-30 hours, specifically about 15-25 hours.

The polymerizable monomer substance may, for instance, be selected from the group consisting of acrylic acid, butyl acrylate, benzyl acrylate, hydroxyethyl methacrylate (HEMA), 2-hydroxypropyl methacrylate (HPMA), alkyl 2-cyanoacrylates, for example cyanoethyl acrylate (ECA), methacrylic acid, methyl methacrylate (MMA), butyl methacrylate, benzyl methacrylate, styrene, a-methylstyrene, 4-vinylpyridine, vinyl chloride, vinyl alcohol, vinyl acetate, vinyl ether, N-isopropylacrylamide (NIPAM), acrylamide, methacrylamide, isocyanates and combinations thereof.

The polymerization initiator may, for instance, be selected from the group consisting of 2,2′-azobis(2-methylbutyronitrile), dimethyl 2,2′-azobis(2-methylpropionate), dimethyl 2,2′-azobisisobutyrate, 2,2′-azoisobutyronitrile (AIBN), dibenzoyl peroxide, water-soluble initiators, for example potassium peroxodisulfate, and combinations thereof.

In one embodiment R₁ is C, (CH₂)₁₋₆—C, or (CH₂)₁₋₆—O(O)C—C.

In one embodiment R₂ is CR₄R₅, where R₄ and R₅ are independently selected among H and C₁-C₆ alkyl.

In one embodiment R₂ is CR₄R₅, where R₄ is H and R₅ is C₁-C₆ alkyl.

In one embodiment R₃ is H, halo, C₁-C₆ alkyl, or C₁-C₆ haloalkyl.

In one embodiment R₁ is C or (CH₂)₁₋₃—O(O)C—C; R₂ is CH₂; and R₃ is H, halo, C₁-C₃ alkyl, or C₁-C₃ haloalkyl.

In one embodiment R₁ is C; R₂ is CH₂; and R₃ is H, halo, C₁-C₂ alkyl, or C₁-C₂ haloalkyl.

In one embodiment R₁ is C; R₂ is CH₂; and R₃ is H or C₁ alkyl.

In one embodiment the metal oxide complex with organic ligands consists of cerium(III)acetate; the polymerizable monomer substance is hydroxyethyl methacrylate; KAT⁺ is H⁺; R₁ is C; R₂ is CH₂; R₃ is H or C₁ alkyl; and the polymerization initiator is 2,2′-azoisobutyronitrile.

Another aspect of the invention relates to a polymer composite that is obtainable by the inventive process. One embodiment of this aspect relates to a polymer composite that is obtained by the inventive process.

Another aspect of the invention relates to a composition comprising

(a) an organic material subject to oxidative, thermal or light-induced degradation, and

(b) functionalized particles according to the invention.

In one embodiment the inventive composition is a coating composition.

In another embodiment of the inventive composition component (a) is a polymer.

Another aspect of the invention relates to a nanocomposite comprising a polymer and functionalized particles according to the invention.

In one embodiment of the inventive nanocomposite the polymer is an elastomer.

The invention will be illustrated in closer detail in the following non-limiting examples.

### EXAMPLES

### Materials and Methods

Cerium(III)nitrate hexahydrate, cerium(III)acetate hydrate, methacrylic acid, sodium methacrylate, and polyethylene glycol diacrylate with an average molecular weight of 250 g·mol⁻¹ were purchased from Sigma-Aldrich. Hydrogen peroxide 30% was purchased from MERCK. Methyl methacrylate was kindly provided by Resiquimica. 2,2-dimethoxy-2-phenylacetophenone (Irgacure 651) was provided by Ciba Specialty Chemicals (Switzerland). NYACOL® CeO2(AC) was provided by Nyacol Nano Technologies, USA. 2-Hydroxyethyl methacrylate (HEMA), acrylic acid and 2,2′-Azobis(2-methylpropionitrile) (AIBN) were purchased from Sigma-Aldrich. Ethanol and acetone were provided from VWR. All chemicals were used as received. Double distilled water was used for all examples.

Powder X-ray diffraction (PXRD) studies were conducted in a PANalytical X'Pert Pro diffractometer using Cu radiation. An aliquot of the sample was first dried at room temperature for 72 hours. The sample was then blended with tetrahydrofuran (THF) and a paste was formed. This paste was applied onto the silicon wafer used as support for PXRD analysis and it resulted in a thick transparent film (biscuit). The film was then gently washed with double distilled water to remove any water soluble residues prior to analysis.

Fourier Transform Infrared Spectrometry (FTIR) studies were conducted with a PerkinElmer Fourier transform infrared (FTIR) spectrometer, Spectrum One with Attenuated Total Reflection (ATR) sampling accessory and used with a MIR (mid-infrared) beam source. The instrument is equipped with KRS-5 and diamond ATR crystals on the top plate and with a MIR-DTGS (mid-infrared deuterated triglycine sulfate) detector. When needed, samples were dried overnight in a vacuum oven at room temperature. A few milligrams of sample were placed directly on the ATR crystal. Spectra were recorded with 16 scans and a resolution of 2 cm⁻¹. Samples of the polymerized films were placed directly on top of the ATR-crystal and gently pressed to obtain good contact between the sample and the crystal.

The UV-Vis spectra of the cured thin films were obtained using a Perkin Elmer Lambda 1050 UV-Vis-NIR spectrophotometer equipped with an integrating sphere. The spectral range covered was 250-800 nm at a scan speed of 120 nm·min⁻¹ and with a resolution of 1 nm. Pressed BaSO₄ was used as a reflectance reference.

Dynamical mechanical analysis (DMA) tests were performed on a TA instruments DMA, model Q800 in tensile mode. The samples for the DMA measurements were of 5×36×0.15 mm as made in the Teflon mold. The samples were mounted in the sample holder, and the temperature then set to 25° C. as starting temperature. The temperature was then raised at 3° C.·min⁻¹ up to 150° C. as data were recorded. The oscillation frequency was held at 1 Hz at an amplitude of 10.0 mm

Thermogravimetry analyses were carried out in a Perkin-Elmer TGA analyzer.

For Examples 1-8B, the temperature was set to increase from 25° C. to 800° C. at the rate of 20° C.·min⁻¹; the air gas flow was set to 40 mL/min; and the residue on the crucible after reaching 800° C. is the value given as the weight % concentration of the dispersions.

For Examples 9A-10B, the temperature was set to increase from room temperature to 120° C., where it was kept for 10 minutes before continuing to 700° C. at the rate of 10° C.·min⁻¹ with N₂ flow changing to O₂ at 400° C., both at 30 mL·min⁻¹.

### Example 1—Preparation of Functionalized Particles from Particle Precursor

150 mL distilled water was filtered through a 1.2 μm Supor membrane and 3.50 grams of cerium(III)acetate was added to a 250 mL bottle sealed with a Teflon cap. The solution was stirred with a 50×8 mm Teflon coated magnetic bar at 400 rpm during 4 hours. If impurities such as dust were visible with the naked eye, the solution was filtered again through the 1.2 μm Supor membrane filter. 0.86 grams of methacrylic acid was then added and the solution maintained stirred for 30 minutes. The stirring was then increased to 600 rpm and 1.2 grams of H₂O₂ added all at once. It was then left under stirring at 600 rpm for 10 minutes, and then reduced to 400 rpm for 20 minutes. The resulting solution was then used without further treatments. The obtained sample is referred to as sample Ac1.

Successful complexation of the methacrylic acid on the surface of the particles was confirmed by the shift shown on FTIR, which is dependent on the metal to which the acid is coordinated. FTIR spectra showed that the asymmetric vibration of the carboxylate group shifted from 1690 cm⁻¹ in the methacrylic acid to 1516 cm⁻¹ when complexing cerium atoms on the ceria surface.

### Example 2—Preparation of Functionalized Particles from Particle Precursor

150 mL distilled water was filtered through a 1.2 μm Supor membrane and 3.50 grams of cerium(III)acetate was added to a 250 mL bottle sealed with a Teflon a cap. The solution was stirred with a 50×8 mm Teflon coated magnetic bar at 400 rpm during 4 hours. If impurities such as dust were visible with the naked eye, the solution was filtered again through the 1.2 μm Supor membrane filter. 0.86 grams of methacrylic acid was then added and the solution maintained stirred for 30 minutes. 10 grams of polyethylene glycol diacrylate (PEG-DA) of Mn 250 was added and the solution stirred for 30 more minutes. The stirring was then increased to 600 rpm and 1.2 grams of H₂O₂ added all at once. It was then left under stirring at 600 rpm for 10 minutes, and then reduced to 400 rpm for 20 minutes. The resulting solution was then left at rest overnight and after phase separation, the monomer phase was collected. The obtained sample is referred to as sample Ac2.

### Example 3—Preparation of Functionalized Particles from Particle Precursor

150 mL distilled water was filtered through a 1.2 μm Supor membrane and 3.50 grams of cerium(III)acetate was added to a 250 mL bottle sealed with a Teflon cap. The solution was stirred with a 50×8 mm Teflon coated magnetic bar at 400 rpm during 4 hours. If impurities such as dust were visible with the naked eye, the solution was filtered again through the 1.2 μm Supor membrane filter. 0.86 grams of methacrylic acid was then added and the solution maintained stirred for 30 minutes. 10 grams of polyethylene glycol diacrylate (PEG-DA) was added and the solution stirred for 30 more minutes. The stirring was then increased to 600 rpm and 1.2 grams of H₂O₂ added all at once. It was then left under stirring at 600 rpm for 10 minutes, and then reduced to 400 rpm for 20 minutes. The resulting solution was freeze-dried to produce a wet powder, which was collected in a 30 mL vial with the addition of 15 more grams of PEG-DA. The obtained sample is referred to as sample Ac3.

### Example 4—Preparation of Functionalized Particles from Particle Precursor

150 mL distilled water was filtered through a 1.2 μm Supor membrane and 0.434 grams of cerium(III)nitrate hexahydrate was then added to a 250 mL bottle sealed with a Teflon cap. The solution was stirred a 50×8 mm Teflon coated magnetic bar at 400 rpm for 4 hours. If impurities such as dust were visible with the naked eye, the solution was filtered again through the 1.2 μm Supor membrane filter. 1.08 grams of sodium methacrylate was then added and the solution and maintained stirring for 30 minutes. The stirring was then increased to 600 rpm and 1.2 grams of H₂O₂ was added all at once. It was left under stirring at 600 rpm for 10 minutes and then reduced to 400 rpm for 20 minutes. The resulting solution was then used as such. The obtained sample is referred to as sample N1.

### Example 5—Nanocomposite Formation by Direct Polymerization with MMA

150 ml of sample Ac1 was placed in a 250 mL bottle. 1 g MMA and 5 mg potassium persulphate (KPS) were then added to the dispersion. A stirring bar was placed in the bottle and nitrogen gas was flushed for removal of oxygen in the headspace. The bottle was then sealed with its Teflon screw cap and placed in a water bath at 70° C. with continuous stirring for 4 hours. The obtained sample is referred to as Ac1-PMMA.

### Example 6—Nanocomposite Formation by Direct Polymerization with MMA

150 ml of sample N1 was placed in a 250 mL bottle. 1 g MMA and 5 mg potassium persulphate (KPS) were then added to the dispersion. A stirring bar was placed in the bottle and nitrogen gas was flushed for removal of oxygen in the headspace. The bottle was then sealed with its Teflon screw cap and placed in a water bath at 70° C. with continuous stirring for 4 hours. The obtained sample is referred to as N1-PMMA.

It was confirmed, for Ac1-PMMA as well as for N1-PMMA, that the formed polymer precipitates together with the nanoceria and can thus be separated from the aqueous solution by filtration. This was visually seen as the precipitate was pale yellow while the remaining water solution transformed from bright yellow to a colourless appearance.

A TGA analysis of Ac1-PMMA as well as of N1-PMMA unveiled that 98 wt % of the nanoceria was incorporated into the polymer composite. The presence of ceria in the polymer matrices was further confirmed by PXRD measurements showing a match with a ceria reference pattern.

### Example 7A—Polymerization of Nanocomposite Thermoset

2.5 g of Ac2 was mixed with 0.025 g Irgacure 651 (1% w/w) in a 10 ml vial until the initiator was completely dissolved. Films were then made on a quartz plate using by adding a few drops on the plate and then subsequently covering the liquid with rigid PET film to form a film of approximately 100 mm thickness. The sample was then irradiated for 5 minutes with the UV source at ambient temperature. The light source used for curing was a Black Ray B-100AP (100 W, 365 nm) Hg UV lamp, which after the aforementioned irradiation time subjects the sample to a total dose of 4.8 J cm⁻², as determined using an Uvicure Plus High Energy UV Integrating Radiometer (EIT, USA), measuring UVA at 320-390 nm. The PET films were then removed from the sample. The specimen was then evaluated using UV-Vis.

### Reference Example 7B—Polymerization of Thermoset without Functionalized Particles

Example 7A was repeated with the exception that a solution prepared according to Example 2, but without cerium(III)acetate, was used instead of Ac2.

Example 7A resulted in a yellow clear solid film with well dispersed particles. The UV-Vis evaluation showed that the UV absorbance of the film from Example 7A was enhanced in relation to that of the film from Reference Example 7B.

### Example 8A—Polymerization of Nanocomposite Thermoset

2.5 g of Ac3 was mixed with 0.025 g Irgacure 651 (1% w/w) in a 10 ml vial until the initiator was completely dissolved. The formulation was transferred to a Teflon mold with a sample shape of 5×36×0.15 mm. The sample was then covered with a microscope glass slide and the sample irradiated for 5 minutes with a UV source at ambient temperature. The glass slide was then removed and the sample post cured thermally at 100° C. for one hour. The cured sample was then removed from the mold for evaluation using FTIR and DMA.

### Reference Example 8B—Polymerization of Thermoset without Functionalized Particles

Example 8A was repeated with the exception that a solution prepared according to Example 3, but without cerium(III)acetate, was used instead of Ac3.

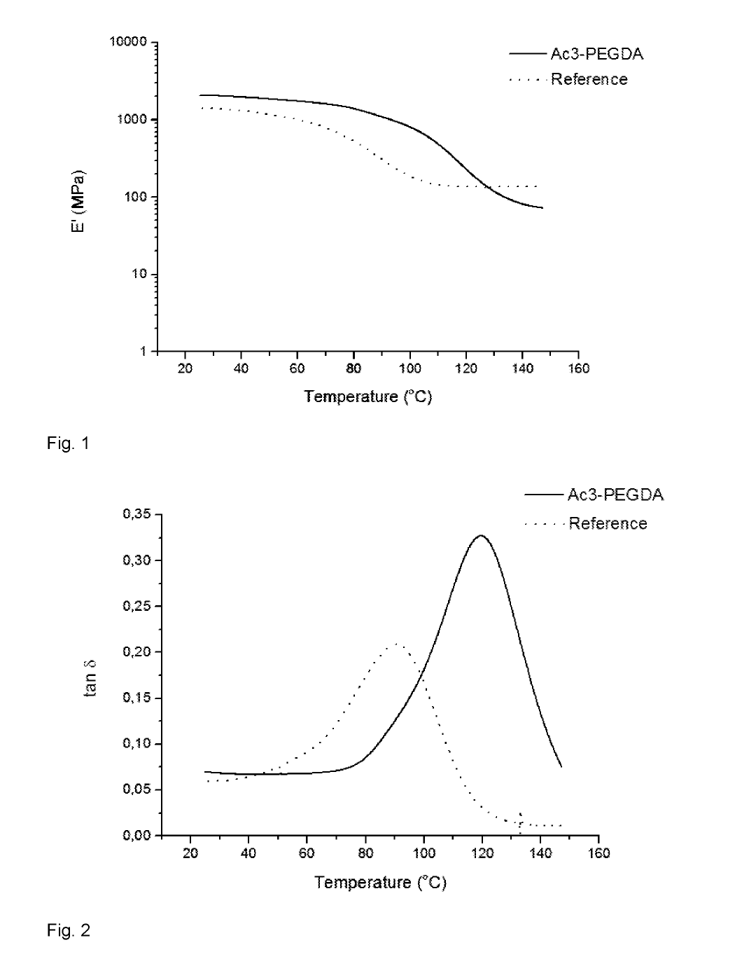

Example 8A resulted in resulted in clear transparent film with a good mechanical integrity. The film exhibited a significant improvement in mechanical performance compared to the corresponding film obtained by Reference Example 8B, which is shown by FIGS. 1 and 2. The Tg, as determined by the tand peak value, was also shifted upwards from 90° C. to 120° C. indicating a very strong reinforcing effect of the functionalized particles. It could be concluded that the functionalized particles contribute strongly to the mechanical properties of the nanocomposite.

### Example 9A—Nanocomposite Formation with Modified Commercial Particles

10 grams of ceria nanoparticle dispersion NYACOL® CeO₂(AC) and 10 grams of HEMA were mixed together in a 30 mL vial. Then, 1 gram of acrylic acid was added. The vial was gently agitated for 6 hours at room temperature but protected from light. Separately, an AIBN solution in acetone at a concentration of 10 wt % was prepared and then added to the vial. After shaking the vial was placed in oven at 75° C. for 4 hours and then kept overnight (16 hours) at 50° C.

### Reference Example 9B—Nanocomposite Formation without Particles

Example 9A was repeated with the exception that no ceria nanoparticle dispersion was used.

### Example 10A—Nanocomposite Formation with Modified Commercial Particles

5 grams of NYACOL® CeO₂(AC), 5 grams of distilled water, 5 grams of ethanol and 5 grams of HEMA were mixed together in a 30 mL vial. Then, 1 gram of acrylic acid was added. The vial was gently agitated for 6 hours at room temperature but protected from light. Separately, an AIBN solution in acetone at a concentration of 10 wt % was prepared and then added to the vial. After shaking the vial was placed in oven at 75° C. for 4 hours and then kept overnight (16 hours) at 50° C.

### Reference Example 10B—Nanocomposite Formation without Particles

Example 10A was repeated with the exception that no ceria nanoparticle dispersion was used.

For each one of Examples 9A, 9B, 10A, and 10B, the nanocomposites were taken out of the vials where the polymerizations had occurred. Two specimens were cut from each one of the nanocomposites. One of the specimens was placed in a volume of water 350 times that of the specimen for 18 hours. Then, the specimen was placed in the same volume of fresh water, and left for another 18 hours. The two specimens were dried together in a vacuum oven to ensure identical drying conditions. TGA analyses of all specimens were carried out.

Examples 9A and 10A yielded hydrogels with enough structural strength to allow them to be removed from the vials. A double bond conversion of more than 95% was confirmed by FTIR analyses of dried specimens of Examples 9A and 10A, seen as a disappearance of the double bond vibration around 1640 cm⁻¹. The samples were yellow, transparent and clear monolithic structures with rubbery mechanical behavior. They could easily be bent without fracturing and retained their shape as formed in the vial.

The samples of Reference Examples 9B and 10B, however, did not form any monolithic structures but rather partly phase separated white mixtures without any apparent structural shape.

The difference between the samples of Examples 9A and 10A compared to the samples of Reference Examples 9B and 10B indicates that the ceria particles are covered on their surface by acrylic acid and that these group copolymerize with the HEMA. In this way, each ceria particle (having multiple acrylate monomers on its surface) acts as a crosslinking site. Since the starting ceria particle dispersion was modified by acetate groups, a ligand exchange reaction must have taken place.

To corroborate whether the acrylate bound to the ceria particles was resistant to hydrolysis, a leaching experiment was conducted on samples from Examples 9A and 10A. Immersing the resulting nanocomposites in abundant water and for a long period of time, would result in the leaching of nanoparticles if these are not strongly bound to the polymer surrounding.

A comparison of the specimens subjected to the leaching test, compared to reference samples not subjected to leaching of the corresponding sample revealed that for all the immersed specimens, the relative concentration of inorganic residue was slightly higher than that of the reference, see Table I. This can be explained by the leaching of residual monomers or oligomers not participating in the thermoset structure (i.e. free chains).

TABLE I
TGA analyses on samples from Examples 9A and 10A before
and after leaching.

| | Reference | Leached |
|---|---|---|
| Examples 9A | 15.3 ± 0.6 wt % | 17.9 ± 0.8 wt % |
| Examples 10A | 15.0 ± 0.9 wt % | 17.0 ± 0.4 wt % |

### Example 11—Preparation of Functionalized Particles from Modified Commercial Particles

12 grams of ceria nanoparticle dispersion NYACOL® CeO₂(AC) are mixed with an amount of 3.1 grams acetone. Then 0.6 gram acrylic acid is added. This is stirred for four hours without any lid or seal (to allow acetic acid to evaporate). The resulting ceria nanoparticle dispersion is thereby modified with acrylate groups.

### Example 12—Preparation of Functionalized Particles from Modified Commercial Particles

Same as Example 11, except that THF is used instead of acetone.

### Example 13—Preparation of Functionalized Particles from Modified Commercial Particles

Same as Example 11, except that dimethyl sulfoxide (DMSO) is used instead of acetone.

### Example 14—Preparation of Functionalized Particles from Modified Commercial Particles

12 grams of ceria nanoparticle dispersion NYACOL® CeO₂(AC) are mixed with an amount of 3.1 grams acetone. Then 0.6 gram methacrylic acid is added. This is stirred for four hours without any lid or seal (to allow acetic acid to evaporate). The resulting ceria nanoparticle dispersion is thereby modified with methacrylate groups.

### Example 15—Preparation of Functionalized Particles from Modified Commercial Particles

Same as Example 14, except that THF is used instead of acetone.

### Example 16—Preparation of Functionalized Particles from Modified Commercial Particles

Same as Example 14, except that DMSO is used instead of acetone.

### Example 17—Preparation of Functionalized Particles from Modified Commercial Particles

Same as Example 11, except that NYACOL® ZrO₂(AC) is used instead of NYACOL® CeO₂(AC)

### Example 18—Preparation of Functionalized Particles from Modified Commercial Particles

Same as Example 14, except that NYACOL® ZrO₂(AC) is used instead of NYACOL® CeO₂(AC)

### Example 19—Nanocomposite Formation with Modified Commercial Particles

10 grams of ceria nanoparticle dispersion NYACOL® CeO₂(AC) and 10 grams of HEMA are mixed together in a 30 mL vial. Then, 1 gram of acrylic acid is added. The vial is gently agitated for 6 hours at room temperature but protected from light. Separately, an AIBN solution in acetone at a concentration of 10 wt % is prepared and then 0.5 grams of this solution is added to the vial. After shaking the vial is placed in oven at 75° C. for 4 hours and then kept overnight (16 hours) at 50° C.

### Example 20—Nanocomposite Formation with Modified Commercial Particles

Same as Example 19, except that methacrylic acid is used instead of acrylic acid.

### Example 21—Nanocomposite Formation with Modified Commercial Particles

Same as Example 19, except that poly(ethylene glycol) diacrylate (PEGDA) monomer is used instead of HEMA.

### Example 22—Nanocomposite Formation with Modified Commercial Particles

Same as Example 19, except that NYACOL® ZrO₂(AC) is used instead of NYACOL® CeO₂(AC).

### Example 23—Nanocomposite Formation with Modified Commercial Particles

10 grams of zirconia nanoparticle dispersion NYACOL® ZrO₂(AC) and 10 grams of HEMA are mixed together in a 30 mL vial. Then, 1 gram of methacrylic acid is added. The vial is gently agitated for 6 hours at room temperature but protected from light. Separately, an AIBN solution in acetone at a concentration of 10 wt % is prepared and then 0.5 grams of this solution is added to the vial. After shaking the vial is placed in oven at 75° C. for 4 hours and then kept overnight (16 hours) at 50° C.

1. A functionalized particle comprising, bound to its surface, a radical of formula I 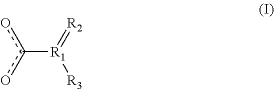
wherein the particle comprises an oxide of a metal; R₁ is C, (CH₂)₁₋₁₂—C, or (CH₂)₁₋₁₂—O(O)O—C; R₂ is CR₄R₅, where R₄ and R₅ are independently selected among H and C₁-C₁₂ alkyl; and R₃ is H, halo, C₁-C₁₂ alkyl, or C₁-C₁₂ haloalkyl.

2. The functionalized particle according to claim 1, wherein the particle consists of CeO₂; R₁ is C; R₂ is CH₂; and R₃ is H or C₁ alkyl.

3. A process for the production of functionalized metal oxide particles, comprising the sequential steps of:
(A) providing an aqueous solution of a particle precursor comprising a metal salt;
(B) adding to said aqueous solution a modifier substance of formula II 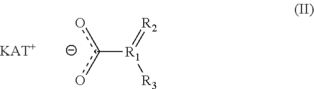
wherein KAT⁺ is H⁺ or an alkali metal; R₁ is C, (CH₂)₁₋₁₂—C, or (CH₂)₁₋₁₂—O(O)C—C; R₂ is CR₄R₅, where R₄ and R₅ are independently selected among H and C₁-C₁₂ alkyl; R₃ is H, halo, C₁-C₁₂ alkyl, or C₁-C₁₂ haloalkyl; and (C) adding to said aqueous solution an oxidizing agent, whereby no part of the process is performed at a temperature exceeding 30° C.

4. The process according to claim 3, wherein the process is carried out in the substantial absence of any substance that could cause the produced metal oxide particles to precipitate.

5. The process according to claim 3, wherein said particle precursor consists of cerium(III)acetate; R₁ is C; R₂ is CH₂; R₃ is H or C₁ alkyl; and the oxidizing agent is H₂O₂.

6. A process for the production of functionalized particles, which process comprises mixing a dispersion of particles of a metal oxide complex with organic ligands with a modifier substance of formula III 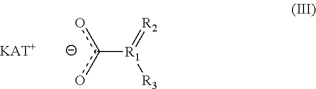
wherein KAT⁺ is H⁺ or an alkali metal; R₁ is C, (CH₂)₁₋₁₂—C, or (CH₂)₁₋₁₂—O(O)C—C; R₂ is CR₄R₅, where R₄ and R₅ are independently selected among H and C₁-C₁₂ alkyl; and R₃ is H, halo, C₁-C₁₂ alkyl, or C₁-C₁₂ haloalkyl.

7. The process according to claim 6, wherein said metal oxide complex with organic ligands consists of cerium(III)acetate; KAT⁺ is H⁺; R₁ is C; R₂ is CH₂; and R₃ is H or C₁ alkyl.

8. A functionalized metal oxide particle, obtainable by the process according to claim 3.

9. A process for the production of a polymer composite comprising functionalized particles, which process comprises the sequential steps of:
(1) Mixing a dispersion of particles of a metal oxide complex with organic ligands with a polymerizable monomer substance;
(2) Adding to the mixture obtained from step (1) a modifier substance of formula IV 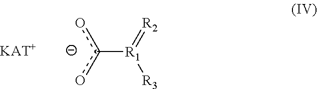
wherein KAT⁺ is H⁺ or an alkali metal; R₁ is C, (CH₂)₁₋₁₂—C, or (CH₂)₁₋₁₂—O(O)C—C; R₂ is CR₄R₅, where R₄ and R₅ are independently selected among H and C₁-C₁₂ alkyl; R₃ is H, halo, C₁-C₁₂ alkyl, or C₁-C₁₂ haloalkyl; and
(2) Adding a polymerization initiator to the mixture obtained from step (2).

10. The process according to claim 9, wherein said metal oxide complex with organic ligands consists of cerium(III)acetate; KAT⁺ is H⁺; R₁ is C; R₂ is CH₂; R₃ is H or C₁ alkyl; said polymerizable monomer substance is hydroxyethyl methacrylate (HEMA); and said polymerization initiator is 2,2′-azoisobutyronitrile (AIBN).

11. A polymer composite obtainable by the process according to claim 9.
